(19) United States
(12) Patent Application Publication
(10) Pub. No.: US 2015/0294233 A1
(43) Pub. Date: Oct. 15, 2015

(54) SYSTEMS AND METHODS FOR AUTOMATIC METADATA TAGGING AND CATALOGING OF OPTIMAL ACTIONABLE INTELLIGENCE

(71) Applicants: Derek W. Aultman, Holly Springs, NC (US); Michelle D. Aultman, Holly Springs, NC (US)

(72) Inventors: Derek W. Aultman, Holly Springs, NC (US); Michelle D. Aultman, Holly Springs, NC (US)

(21) Appl. No.: 14/683,160

(22) Filed: Apr. 10, 2015

Related U.S. Application Data
(60) Provisional application No. 61/977,811, filed on Apr. 10, 2014.

(51) Int. Cl. G06N 99/00; G06F 17/30

(52) U.S. Cl. CPC G06N 99/005; G06F 17/30722

(57) ABSTRACT

Disclosed herein are systems and methods for automatic metadata tagging and cataloging of optimal actionable intelligence. According to an aspect, a method for automatic metadata tagging and cataloging optimal actionable intelligence includes using at least one processor and memory for receiving at least one training attribute of a plurality of pre-identified attributes. The method further includes creating at least one metadata classifier tag based on the at least one training attribute. The method also includes receiving a data feed from at least one data feed source for analysis based on the at least one metadata classifier tags. The method also includes applying the created metadata classifier tags to the data feed. The method further includes detecting a sensor event based on the applied metadata classifier tag to the data feed.

### CROSS REFERENCE TO RELATED APPLICATION

This application claims the benefit of and priority to U.S. Provisional Patent Application No. 61/977,811, filed Apr. 10, 2014 and titled SYSTEMS AND METHODS FOR AUTOMATIC METADATA TAGGING AND CATALOGING OF OPTIMAL ACTIONABLE INTELLIGENCE; the disclosure of which is incorporated herein by reference in its entirety.

### TECHNICAL FIELD

The present disclosure relates to automatic metadata tagging of data feeds. More specifically, the present disclosure relates to systems and methods for automatic metadata tagging and cataloging of optimal actionable intelligence.

### BACKGROUND

Electronically stored data may be stored serially, for example, in the file directory structure of a computer system, or in an unstructured format, for example, on the Internet. These storage formats were created for their own separate purposes: to make it easy for the operating system to store and retrieve data (in the case of individual computer); and to facilitate the connectivity of large numbers of computers (e.g., Internet). These methods of storing data may make it easier to answer questions about data storage history and geography, such as, for example, when was a file modified, or on which head/cylinder is a file located on disk; and may also make it easier to answer questions about data content, such as, for example, does a text file have a certain phrase in it somewhere or does an image file have a red pixel in it somewhere. However, finding patterns embedded in such electronically stored data may be difficult due to both the amount of data and the lack of appropriate structure to facilitate finding patterns in the data. For example, it may be much more difficult to answer descriptive questions about data, such as whether a file contains an image of a human face, a white motorcycle. Even more difficult to answer are questions of prediction, such as, where did the white motorcycle come from or where the white motorcycle is likely going.

The unstructured data format of the Internet does not improve upon this problem in any qualitative way. To the contrary, the Internet increases the amount of data exponentially, so any solution would likely take longer to find or more computing power to find in the same amount of time.

There are currently several solutions for searching for patterns in electronically stored image data, which may include both video and still images stored in files. A first solution may tag image data with text data. The text data may contain descriptions of the image contents as well as descriptions pertaining to the image contents, such as related phrases. This method requires that image data be tagged before being searched. Tagging may be time-consuming, labor intensive, and of questionable accuracy. A second solution may use neural networks to perform pattern recognition in image data. A neural network may be trained using image data representative of the data being searched for, and may then be used to search through image data. However, the ability of a neural network to perform accurate searches is highly dependent on the quality of the training data, and the neural network may function as a “black box,” making correcting or fine-tuning the operation of a neural network difficult or impossible.

The first solution relies on human analysts to add metadata tags to the image data. Analysts may not know how to add meta-tags or may add intentionally or unintentionally false or misleading metadata tags. Adding metadata tags from an overall catalogue of metadata tags to the image data takes time and effort on the part of analysts. As the amount of image data available to be tagged increases, it becomes no longer feasible to have analysts tag every piece of available image data from an overall catalogue of metadata tags. Current analysts are overwhelmed with hours and hours or large volumes of structured and unstructured data requiring analysis or review. For at least these reasons, there is a need for improved systems and methods for automatic metadata tagging and cataloging of optimal actionable intelligence.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods for automatic metadata tagging and cataloging of optimal actionable intelligence are disclosed herein. According to an aspect, a method for automatic metadata tagging and cataloging optimal actionable intelligence includes using at least one processor and memory for receiving at least one training attribute of a plurality of pre-identified attributes. The method further includes creating at least one metadata classifier tag based on the at least one training attribute. The method also includes receiving a data feed from at least one data feed source for analysis based on the at least one metadata classifier tags. The method also includes applying the created metadata classifier tags to the data feed. The method further includes detecting a sensor event based on the applied metadata classifier tag to the data feed.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of an example system for automatic metadata tagging and cataloging optimal actionable intelligence according to embodiments of the present disclosure;

FIG. 2 is a flowchart of an example method for automatic metadata tagging and cataloging optimal actionable intelligence by receiving training attributes and using the training attributes to create sensor events according to embodiments of the present disclosure;

FIGS. 3A-3E are a process flow diagram of an example system for automatic metadata tagging and cataloging optimal actionable intelligence according to embodiments of the present disclosure; and

FIGS. 4A-4C are screen displays of an example user interface for automatic metadata tagging and cataloging optimal actionable intelligence according to embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. In another example, a computing device may be a server or other computer and communicatively connected to other computing devices (e.g., handheld devices or computers) for data analysis. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

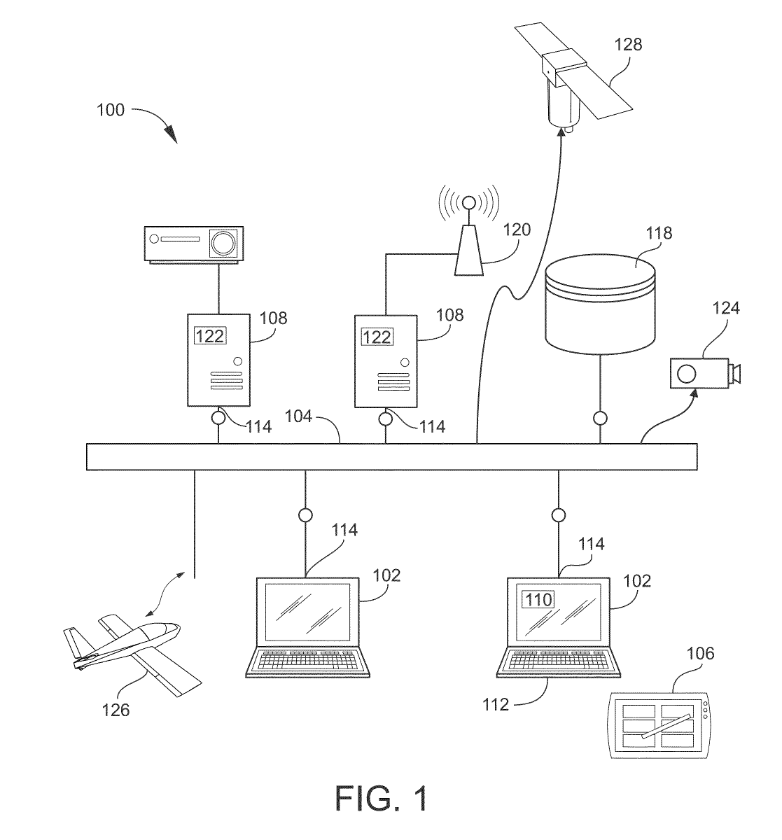

The presently disclosed disclosure is now described in more detail. For example, FIG. 1 illustrates a block diagram of an example system 100 according to embodiments of the present disclosure. The system 100 may be implemented in whole or in part in any suitable computing environment. A computing device 102 may be communicatively connected via a communications network 104, which may be any suitable local area network (LAN), either wireless (e.g., BLUETOOTH® communication technology) and/or wired. The computing device 102, a tablet device 106 in communication with the computing device 102, and other components, not shown, may be configured to acquire data within the computing or data analysis environment, to process the data, and to communicate the data to a centralized server 108. For example, the computing device 102 and tablet device 106 may operate together to implement a data analysis function and to communicate data related thereto to the server 108. The server 108 may reside in a local or remote location.

The components of the system 100 may each include hardware, software, firmware, or combinations thereof. For example, software residing in memory of a respective component may include instructions implemented by a processor for carrying out functions disclosed herein. As an example, the computing device 102 may each include a user interface 110 including a display (e.g., a touchscreen display), a barcode scanner, and/or other equipment for interfacing with intelligence personnel and for conducting data analysis. The computing device 102 may also include memory 112. The computing device 102 may also include a suitable network interface 114 for communicating with the network 104. The tablet device 106 may include hardware (e.g., image capture devices, scanners, and the like) for capture of various data within the computing environment. The system 100 may also include a smart phone device 116 configured similarly to the tablet device 106. The system 100 may also comprise a database 118 for storage of grammatical rules, word and phrase definitions and meanings, as an example. Further, the server 108 may be connected to the computing devices 102 via the network 104 or via a wireless network 120.

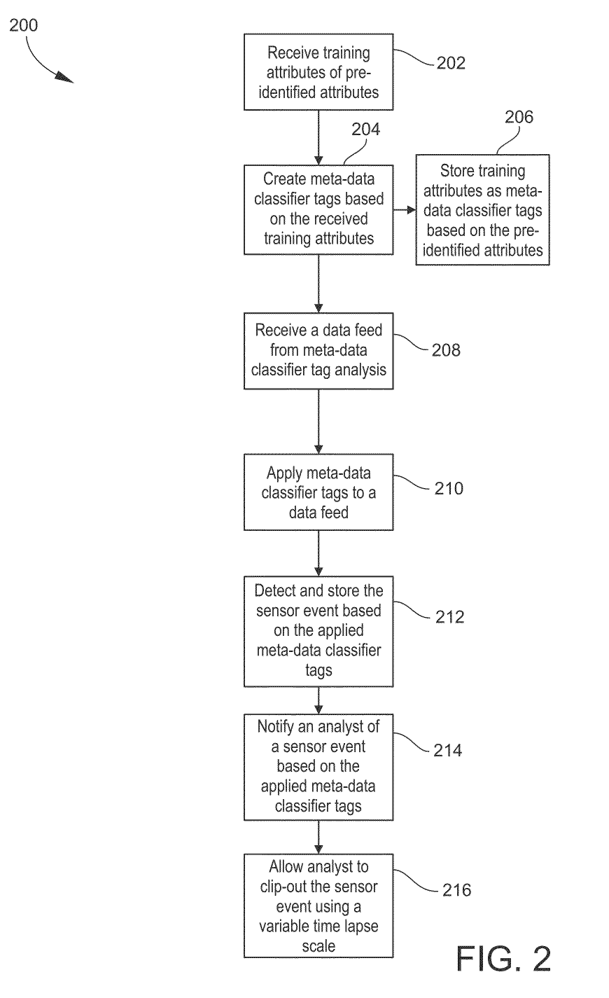

With continued reference to FIG. 1, the system 100 comprising at least a processor and memory of a computing device and a metadata classifier system 122 is provided. As will be described in further detail in FIGS. 2-4 the metadata classifier system 122 is configured to receive training attributes for automatically creating metadata classifier tags for tagging a data feed. Further, the metadata classifier system 122 is configured to store the created metadata classifier tags in the database 118. The database 118 may also be used to store the data feed or identified portions of the data feeds based on analysis using automatic metadata tagging using the metadata classifier tags. It should be noted that the database 118 may be located either internal or external to the servers 108.

The metadata classifier tags may be applied to a data feed provided by several different data feed sources. As described above a data feed source may be the database 118, a video camera 124 for, as an example, full motion video or image stills. The data feed may also be provided by sources, such as, unmanned aerial vehicles (UAV) 126 or satellites 128. The data feed provided may be provided by any source of digital or analog sensor data, whether text, audio, visual, or other.

FIG. 2 illustrates a flowchart of an example method 200 for implementing automatic metadata tagging and cataloging optimal actionable intelligence according to embodiments of the present disclosure. This method is described by example as being implemented by the computing device 102 in FIG. 1, although it should be understood that the method may alternatively be implemented by any suitable computing device or system.

Referring to FIG. 2, the method 200 includes using at least one processor and memory for receiving 202 one or more training attributes of a plurality of pre-identified attributes. As an example, the pre-identified attributes may include particular attributes of a person (e.g., height, hair color, name, age, and the like). The pre-identified attributes may originate from a variety of sources which may include one or more databases or from an intelligence team of analysts, the pre-identified attributes may be based on the intelligence needs of a particular event, a mission or a series of events. The intelligence team may be comprised of people in the intelligence community, such as, analysts, pilots, and engineers, etc. As a non-limiting example, the intelligence team may identify one or more training attributes to be used, where the training attributes are selected from a list of pre-identified attributes to “train” the system on what attributes to search for. The list of pre-identified attributes may include people, objects or events. As an example, the intelligence team may be interested in a particular person with a limp, a tattoo, or a particular name, the intelligence team may even have interest in a group of persons affiliated with the particular person. In another example, the intelligence team may have interest in a type of truck or even a type of truck of a particular color. A further example, may include the intelligence team having interest in a set of vehicles driven by a person or group of persons that attend a meeting or frequenting a particular destination on a particular day or set of days. The intelligence team may select from a list of pre-identified attributes of interest and record these as training attributes. Using the recorded training attributes, the metadata tagging system 122 may receive the training attributes as inputs by an engineer on the intelligence team using the user interface 110, a database 118 or an application programming interface (API), as an example. As an example, the engineer interfacing with the metadata tagging system 122 may use a prepopulated catalog in the user interface 110.

The method 200 includes creating 204 at least one metadata classifier tag based on the at least one training attribute. The metadata classifier tag may be an object classifier determined or defined using manual selection from the intelligence team, or using a method of automated selection by the computing device 102 based on stored or learned training attributes. A metadata classifier tag may be a non-hierarchical keyword or term assigned to a training attribute or set of training attributes. The method 200 may include storing 206 the training attributes and the created metadata classifier tags in the database 118 for future recall or re-use.

The method 200 includes receiving 208 a data feed from at least one data feed source for analysis based on the at least one metadata classifier tags. The data feed may be formatted in one or more formats and be received from one or more data feed sources. As non-limiting examples, the data feed formats may include a Multi-Spectral Targeting System (MTS) format, FMV (e.g, 30-1000 frames per second, black/white, color, infrared and the like), wide-area motion imagery (WAMI), Autonomous Real-Time Ground Ubiquitous Surveillance (ARGUS) system, GOOGLE™ Earth, geo-located data sets, Internet Relay Chat (IRC), GOOGLE™ Buzz, GOOGLE™ Wave, keyhole markup language (KML), key length value (KLV), Arc Digitized Raster Graphic (ADRG)/Compressed Arc Digitized Raster Graphics (CADRG), Controlled Image Base (CIB), National Imagery Transmission Format (NITF), Digital Terrain and Elevation Data (DTED), GeoTIFF, electronic software download (ESD), Cursor on Target (CoT), Link 16, Motion Picture Experts Group MPEG2/H.264, MPEG2/H.264 payload+Motion Imagery Standards Board (MISB) 0601.X, NATO Standardization Agreement (STANAG) 4609 video files, MICROSOFT™ WIN 7, Elecard, MAINCONCEPT™, FFDShow, Low Latency Network Source Filter (LLNSF), .NET™, Ground Moving Target Indicator Data (GMTI), Electronic Intelligence (ELINT), and Blue Force Track (BFT) Situational Awareness (SA) Messages. The data feed may be structured data, such as formatted text, from a database 118 as an example. The data feed may also be unstructured data such as audio, video, still images and/or the data feed may be text screen-scraped from the internet in chat logs, as an example. The data feed may be any type of digitized data provided via a user interface 110 or API. It is noted that these data feed formats are non-limiting and as described herein, the data feed may be any format understandable by the computing device 102. The data feed format of the originally acquired signal format may be either digital or analog.

The method 200 includes applying 210 the created metadata classifier tags to the received or stored data feed. The metadata classifier tags may be applied directly to the data feed whether the data feed is FMV, audio, telestration, display methodologies, automated RSS/ODBC feeds in real-time, or as the data feed is received from a storage device. Applying the metadata classifier tags to at least one data feed, the whole data feed or any portion of the data feed can be identified or flagged as appropriate for further review by the system or by an analyst. Applying the metadata classifier tags may include tagging or labeling the data feeds with a timestamp, position and changes in vector of velocity of an object. The tagging or labeling of the data feeds may also include an indication of behavior recognition. Applying a metadata classifier tag may include storing a tag with an associated reference in a database, where the associated reference points or refers to a location, event, image and the like within a data feed. Tagging or labeling the data feeds with metadata tags may include physically modifying the image(s), FMV, or audio with relevant information which may be used to notify or clue an analyst to an event within the associated data feed. As non-limiting examples, physically modifying the data feed (e.g., image(s), FMV, audio, etc.) may include altering coloring, manipulating the images, imprinting shapes, labels, timestamps, or embedding other electronic or magnetic signals and the like which may be used to notify an analyst. As an example, the behavior may be a vehicle stopping, making a u-turn, or turning in a particular direction. Other types of behavior may include contact between two (2) persons of interest coming into a defined proximity of a particular location within a defined number of video frames of the data feed. Any type of behavior or event may be identified as a training attribute and labeled as a metadata classifier tag. The data feed may be tagged with the metadata classifier tags after the data feed has been received and stored in the database 118, in the same manner as described. In a second or forensics phase after archival, the system may be able to bookmark, add placeholders, keywords and/or other types of metadata to an archived data feed in real or non-real time. The metadata classifier tags may be added to the data feed in such a manner that the metadata classifier tagged data feed may be used to perform pre-mission briefings, situational awareness or packaging a compiled set of footage as background material, such as threat information, or to provide situational awareness from earlier missions. The system may be configured to make the real-time and non-real-time data feeds (e.g., video streams and the like) available to be viewed, analyzed and enriched with metadata across the entire lifespan of the metadata classifier tagged data feed. The system may also be configured, as a non-limiting example, to provide an electronic programming guide access through a portal with live stream channels, as well as, archived data (e.g., digital video recorder (DVR), video on demand (VoD) and the like).

The method 200 includes detecting 212 a sensor event based on the applied metadata classifier tag to the data feed. As an example, the sensor may be any system, mechanism, sensor or other source providing the data feed to which the metadata classifier tag is applied. A sensor event may be the occurrence of an event of interest based on the applied metadata classifier tag. As an example, a sensor event may occur when a match between a behavior, person or object matches a metadata classifier tag applied to the data feed. Detecting 212 the sensor event may include artificial intelligence based algorithms for entity resolution or data matching, tracking and motion prediction combined with a workflow of key requirements gathered by analysts to enable event detection via actionable intelligence actions. Actions may include, but are not limited to, metadata tagging, alert generation, content management services (CMS) integration or other scriptable activities.

If a sensor event is detected, the method for metadata classifier tagging creates a notification 214 which may alert the method or an analyst of a match or possible match between the metadata classifier tags and data analyzed from the data feed. The notification may be sent to an executable process as an automated feed or to a user interface 110 prompting the analyst for an appropriate response. Based on the notification, as an example, the metadata tagging method may allow the analyst to respond by clipping 216 a portion of the data feed using system or user-defined time lapse of the video feed. The metadata tagging method may allow the analyst to decide on the appropriate length of the video clip to identify. The length of the video clip may be of any time length.

With continued reference to FIG. 2, the method 200 for metadata tagging may subsequently use the sensor event to execute an analysis of historical data feeds using the same or similar metadata classifier tags to identify past events that may be relevant to the mission goals of the intelligence team. In this manner, the task of identifying sensor events is automated such that optimal actionable intelligence may be cataloged and provided to the appropriate systems, databases, APIs or personnel enabling a real-time or near real-time response.

With continued reference to FIG. 2, an example of the method 200 for metadata classifier tagging may be as follows. A camera positioned on a UAV (e.g., a sensor ball) takes video and provides the video data feed to the ground station. The video data feed may be displayed and/or stored on disk for the intelligence team (e.g., engineer, analyst). The intelligence team prior to the mission may pre-identify one or more training attributes, which may be correspond to one or more intelligence markers, intelligence markers may be used by an analyst to define a sensor event of interest during the mission. The pre-identified training attributes may be used to train the software to create metadata classifier tags for visual identity tagging, in this example. The method may clue the analyst that a pre-identified attribute or sensor event is taking place by generating a notification. This may allow the analyst to respond immediately or as appropriate, in almost real-time, to react to the information.

Another example of the method 200 in FIG. 2, may be described as the following. A Predator drone may be scheduled to take off at 1:00 pm and fly a 38-hour mission over a city. The method 200 may include the ability to provide a screen displayed menu that allows an engineer or analyst to sit in the briefing room with an intelligence team. During the intelligence briefing, the team may describe the training attributes they are looking for. The engineer/analyst operating the automatic metadata tagging software may subsequently “train” the system using pre-identified attributes in the screen displayed menu that the Intelligence team may need to look for during the surveillance of the city. The method 200 may apply a metadata tagging algorithm to the provided data feed (e.g., tagging the video) in real-time. An additional window in the user interface may display a library shown as text or on a timeline on the display, the timeline, in this example, indicates all the times at least one of the metadata classifier tags were discovered in the mission/sensor data feed. The analyst may then “clip out” video sections of interest to use for the Intelligence Team debriefing. The clipped out portions of the video should allow for a sliding and adjustable time lapse scale. In other words, it may be analyst driven to decide if it is desired that 5 or 10 minutes, as an example, of sensor data feed on either side of identified sensor event should be included. It is noted that any amount of time for the time lapse may be specified. It may also be desired to be able to save the learned metadata classifier tags created in this example and save it as a pre-defined search. This example may be stored so as to apply the training attributes to data sets from past, present or future data feeds. For example, it may be desired to look for an event or behavioral pattern while the Predator is flying over the City, the method may be configured to identify, and create the video clip outs. It may then be desired to run the same algorithm against stored historical data feeds to identify past events that may be relevant to the mission intelligence team.

Another example may include an example of using the metadata tagging system 122 to analyze and detect actionable intelligence regarding a presidential inauguration event. The presidential inauguration event may desire analysis of multiple data feeds from a variety of data sources as described herein. The data feeds may include, for example, still and full motion imagery, Metro or subway event information, HVI tracking, identification of prohibited items, such as backpacks, coolers, etc. The example may also include behavioral analysis and identification of patterns of life of targeted assets. Another example, may include tracking nefarious behavior in a casino. In this example, the method 200 may include metadata classifier tagging to track multiple assets while desiring to detect multiple events of interest. This example may track license plates in combination with police action events as an indication of suspicious behavior. Further, the system may track “high roller” behavior based on casino comp requests such as, show tickets, free nights, spa treatments or upgraded suite requests. This example may also track an asset based on requests for favorite dealer location, best payout machines or other indications of cheating behavior. Similar to the prior example, the data feeds for analysis may, as an example, be received from multiple sources such as video, police scanners, and reservation databases, etc.

With continued reference to FIG. 2, the method 200 for automatic metadata classifier tagging may include artificial intelligence (AI) based self-training/self-improvement. The method 200 may also adapt to changes in visual and behavior patterns and may automatically train a neural network to lower system entropy and maximize signal to noise ratio. The method 200 may also include motion prediction that allows tracking an object after complete obstruction. The method 200 may include a scriptable alerts generation system. The method 200 may include non-relational and relational storage interfaces for metadata (e.g., ODBC). The method 200 may also provide support of the APACHE HADOOP™ framework. The method 200 may also include mobile device support (e.g., tablet device 106), the ability to visualize data on three-dimensional auto stereoscopic displays, including multi-view displays, geo-tagging, mIRC chat log searching and keyword tagging. Additionally, the method 200 may include video annotation, metadata indexing, video transcoding, image processing, image dissemination, real-time creation of still and motion imagery, and annotation and report creation. The method 200 may be implemented on various system platforms and not be limited to any single operating system or software environment. The method 200 may include tagging, searching and video clip out retrieval by multiple users. The method 200 may also be geospatially and situationally aware. As an example, street-level imagery may be added to a data feed from a Predator drone for increasing insight to the Intelligence Team. The method 200 may also include optical character recognition (e.g., a serial number on a dollar bill, a license plate and the like). The method 200 may also include facial recognition. Additionally, the method 200 may include feeds from a variety of facial recognition databases (e.g., national and homegrown databases). As an example, the method 200 may receive data from the FBI, CIA or a Casino's facial recognition database.

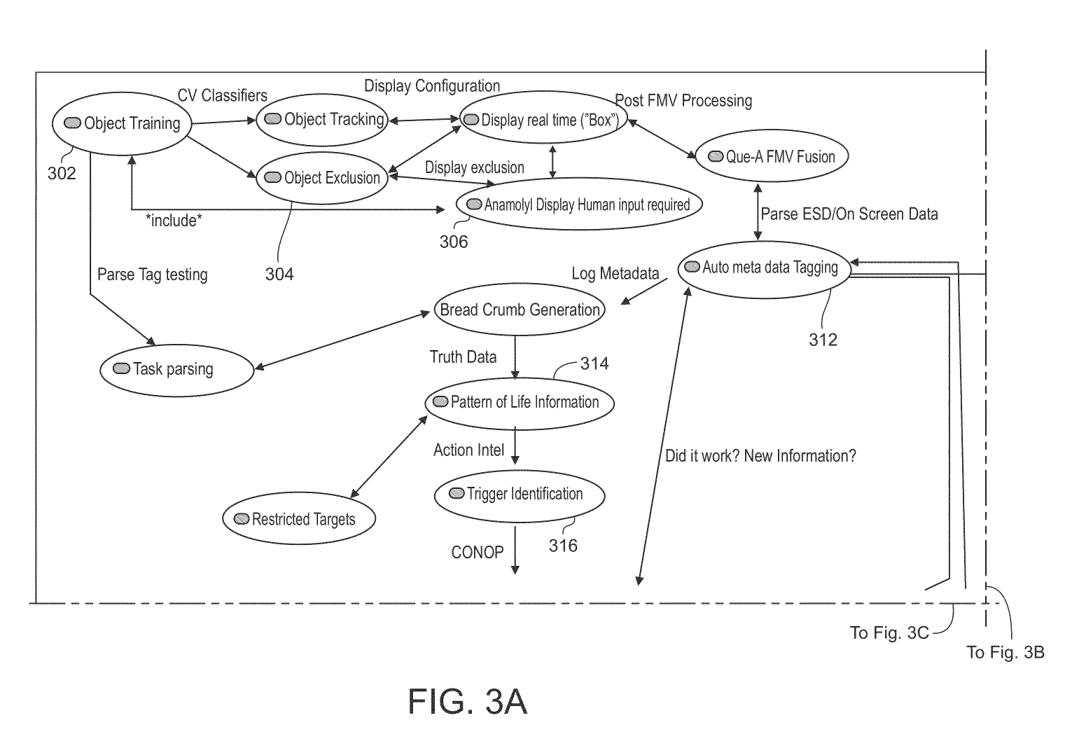

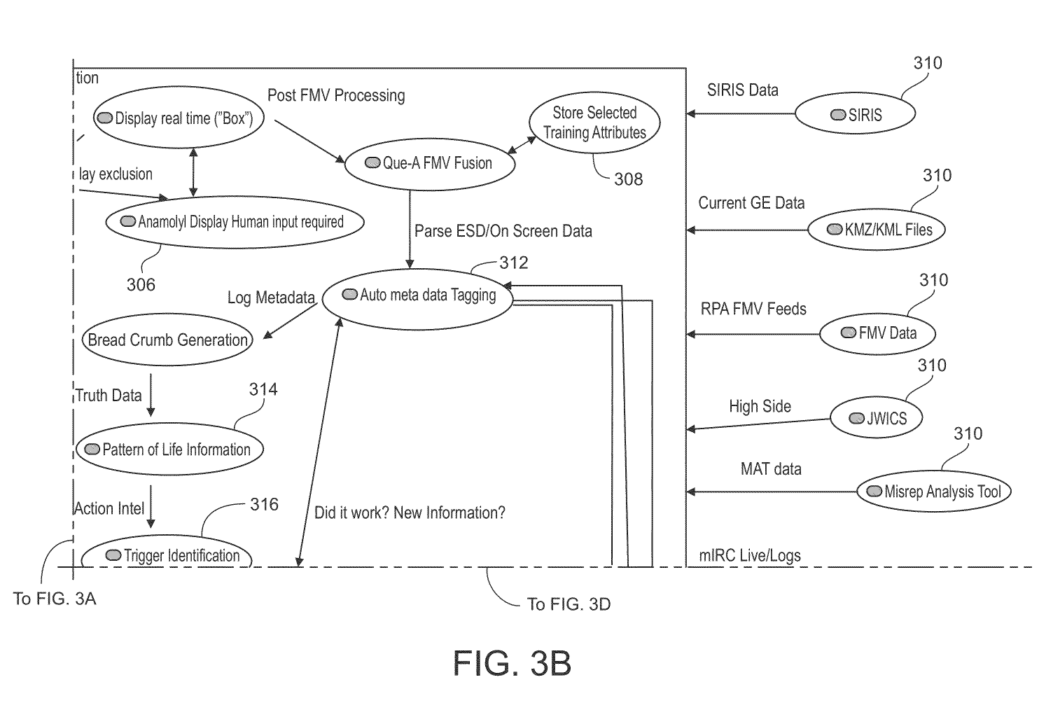

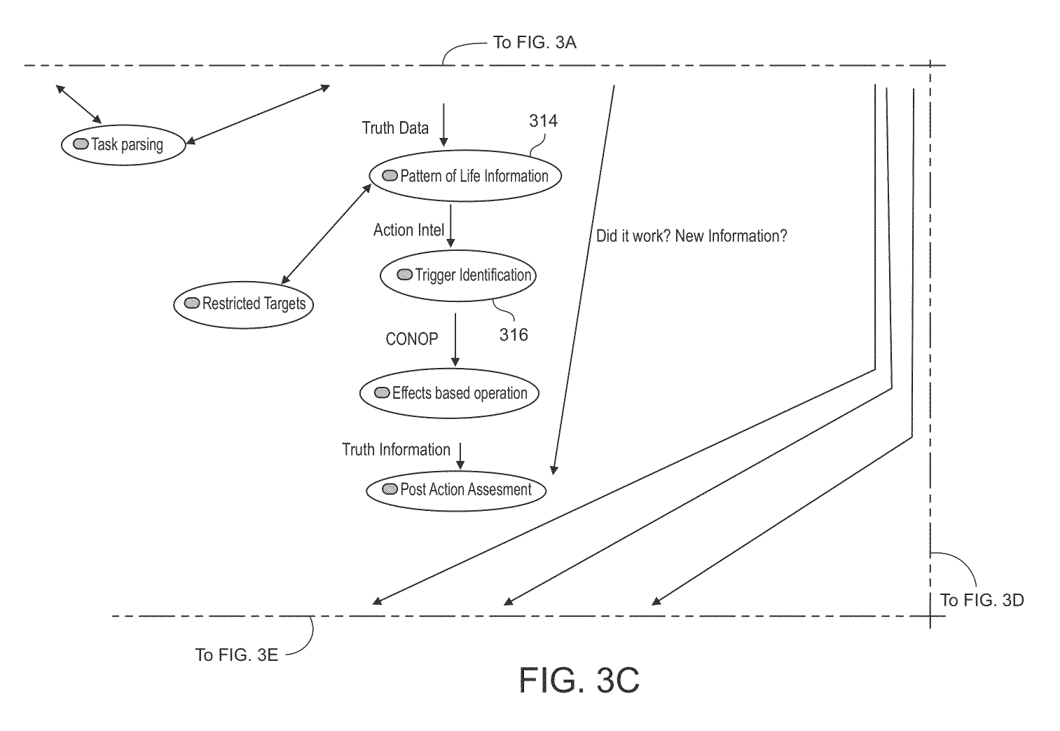

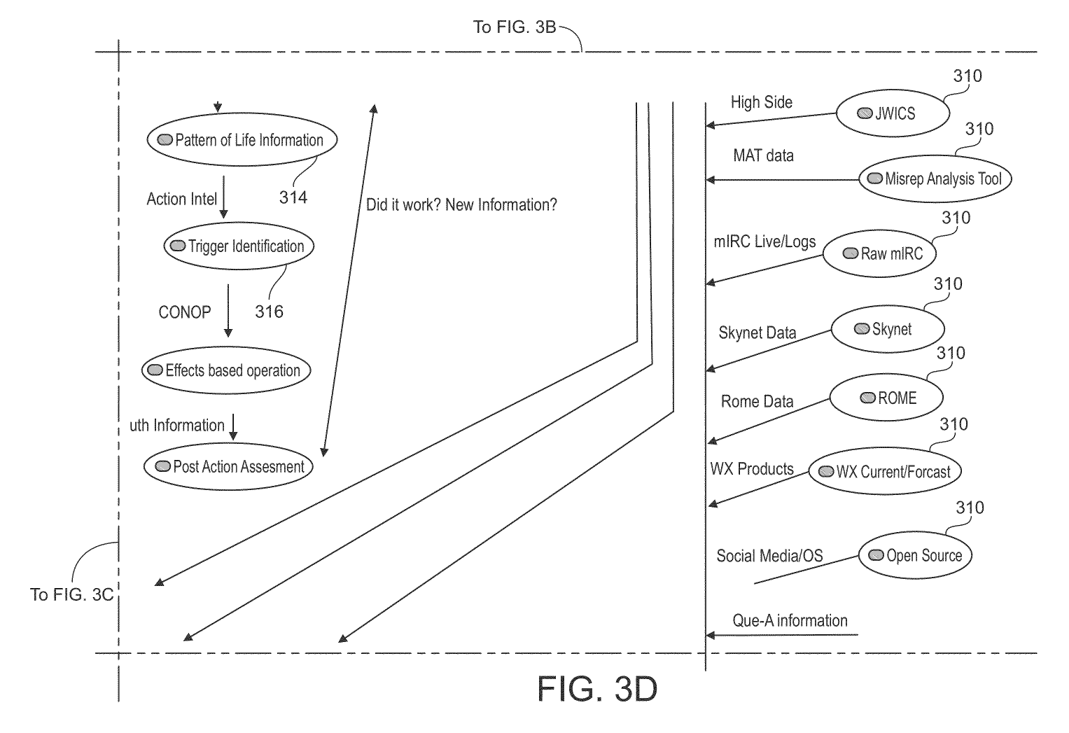

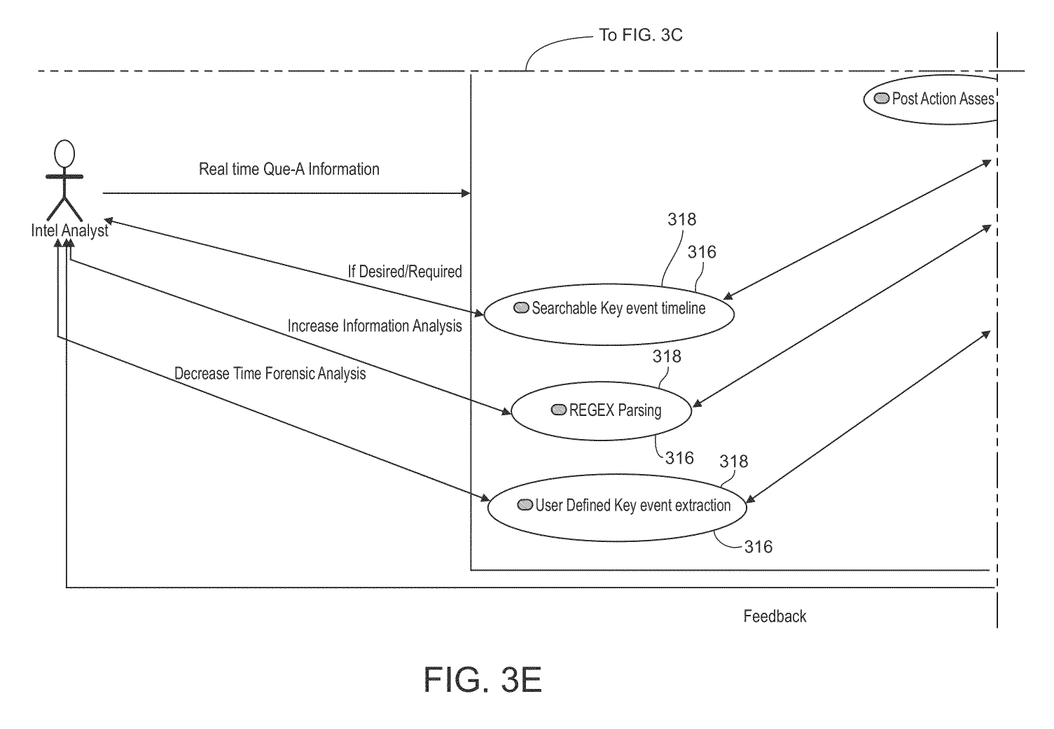

FIGS. 3A-3E illustrate a process flow diagram of an example set of process functions 300 for automatic metadata classifier tagging and cataloging optimal actionable intelligence according to embodiments of the present disclosure. The set of process functions 300 is described as implementing the method 200 of FIGS. 1 and 2, although it should be understood the set of process functions 300 may alternatively be implemented by any suitable method or computing device.

Referring to FIGS. 3A-3E, the set of process functions 300 and relationships included within the metadata tagging system for automatic metadata tagging include receiving training attributes, creating metadata classifier tags, applying metadata classifier tags to the data feed and also generating a notification based on determining a sensor event. The automatic metadata classification tagging system may include executable functions used for receiving 202 training attributes of pre-identified attributes. As an example, in FIG. 3A, the system may use a function, such as, object training 302 to identify an object, a person, a place, a time or some other event to track from a list of pre-identified attributes. It may also be desired to exclude particular objects, people, places, times or other events using a function, such as, object exclusion 304, for example. The method 200 may also include functions to self-train based on changes in visual and behavioral patterns in the assets or objects of interest. The self-training may include automatically training a neural network to lower system entropy and maximize the signal to noise ratio in the data feed, as an example. The self-training may also include functions requiring operator, analyst or human input 306. The method 200 may include functions for storing 308 identified or selected training attributes.

With reference to FIGS. 3B, and 3D the method 200 may include receiving a data feed 310 of any kind from a digital or analog source as described herein. The data feeds 310 may be provided by devices such as surveillance cameras, drones, microphones, etc. The data feeds 310 may also include data from data feed extension points from governmental agencies, such as, the Federal Bureau of Investigation (FBI) and the Central Intelligence Agency (CIA) or non-governmental agencies such as banks or casinos, as non-limiting examples. Additionally, the data feeds 310 may include open source feeds, such as, FACEBOOK™, TWITTER™, GOOGLE™, news networks and the like.

Additionally, the method 200 may include functions for applying 312 the metadata classifier tags to the one or more data feeds 310 based on the selected training attributes 302 and 304. The functions may include metadata classifier tags based identifying patterns of life 314. The functions used for identifying patterns of life 314 may, for example, identify day-time or night-time habits, driving patterns including frequent routes travelled by a person. As another example, functions for identifying patterns of life 314 may also be used to identify financial transactions within a bank account. The functions may include a range of motion prediction capabilities (not shown) that allow the method to continue to track an identified training attribute (e.g., person, object, etc.) that may not be currently visible or detectable in the data feed 310. The method 200 may further include functions for automated metadata tagging 312 of multiple people, objects, or assets within a video frame or portion of a video data feed 310. The functions for automatic metadata tagging may include imagery exploitation, such as, the ability to visualize data on a three-dimensional auto stereoscopic display, image/resolution enhancement. Additionally, the metadata tagging functions 312 may include functions identifying geographical location using geo-tagging to indicate location. The metadata tagging functions 312 may also include tagging the data feed 310 using graphic, textual, audio or other tagging indicators to indicate a sensor event.

With reference to FIGS. 3C and 3E, additional functions may include detecting 316 a sensor event has occurred based on the training attributes selected and the metadata classifier tag applied. Detecting 316 a sensor event may include identifying a match between the training attributes and a detected metadata tag applied to the data feed 310.

With reference to FIG. 3E, subsequent to detecting 316 a sensor event has occurred, automatic metadata tagging and cataloguing functions may include generating a notification 318 used by the system, operator and/or analyst as an example. Generating a notification 318 may also include using a function for scriptable alerts based on behavior or visual analysis with certain combinations of identified metadata classifier tags. The scriptable alerts may initiate video transcoding, image processing and real-time creation of still and motion imagery outputs. The scriptable alerts may also initiate annotation, report generation, storing and retrieval of flagged motion imagery, and optical character recognition (e.g., serial number on a dollar bill or license plate information), as non-limiting examples. Detecting a sensor event may also trigger additional analysis of data feeds.

Other functions include identifying objects for detection by first filtering out noise from a foreground mask. It may be desired that the objects move at a reasonable ‘speed’ (uniform motion or otherwise defined by the training attributes). As an example, the functions for object detection may determine this by keeping a list of object candidate's connected-components for the last 5 frames. This may be based on the frame-to-frame distance change of the object location not exceeding a certain distance in order to qualify as a tracked object, as an example. There may be any number of ways to filter out noise based on connecting or stringing together any number training attributes to define a metadata classifier tag for a sensor event.

Additionally, the system may have functions for blob/object tracking based on filtering schemes, such as, the particle filter based on mean shifting weight (MSPF), the connected component tracking and MSPF resolver for collision (CCMSPF), mean shift tracking (MSFG), particle-filter and the Kalman filter, as an example. The MSFG scheme uses foreground pixels weighted during calculations. A higher value makes the blob accelerates the movements and resizes itself in the model. The MS with Particle Filter may use two hundred (200) particles allocated for each blob/object. Each particle may represent the same blob moving and resizing a little differently from the other particles. The position and size delta of the particle may be generated within some preset variances plus some random value. At the each frame, the particles may be randomized with the new values with the parameters and a weighted sum may yield the new prediction (position, size) of the blob/object. Subsequently, the particles may be shuffled and the weights are reset to 1. Each particle may be associated with a weight and the weights may be updated every frame or any number of frames. The weights are functions of the Bhattacharyya Coefficients calculated between a current Model Histogram and a Candidate Histogram. The Model Histogram may be updated every frame or any number of frames from the blob position and size. The Candidate Histogram is the histogram calculated with the hypothesis particle,

The method 200 may also include functions for behavior analytics. A set of functions may include track coordinates, measure speed and generate vector of velocity of the blob/object. Additionally, functions may include track generation which may include recording the track (position and size) of each blob to a user-specified file. The values of the information may be represented as a fraction of the video frame size. The metadata format may be specified via Extensible Stylesheet Language Transformations (XSLT). XSLT is an XML-based language used for the transformation of XML documents into other XML or “human-readable” documents.

Other functions may include Blob-Track-Analyzers, including histogram analysis of two or more dimensional vectors (2D, 4D, 5D), similarity search (SS) feature-vectors. The blob-track analyzer may include a function to track distance of past blobs/objects (no longer a foreground in recent frames) that may be added to a track database. The tracks of past blobs may be used as templates to compare with the active blob tracks. Additional functions may include finding the closest match from the templates for each active blob in terms of their similarity in position, velocity and/or a state-change of any other attribute of the blob. Additional functions may include determining histograms based on position, velocity and/or state-change. State-change may represent the number of successive frames during which the blob moves very slowly. The “slowness” may be making the blob substantially stationary between frames. Functions may also include a sparse-matrix is used to store the histogram of these continuous vector values, nearby histogram bins may be smoothed at which every new vector is collected. All histograms may be updated at every frame. Further, past blobs may have their histogram(s) merged with a global histogram. Similarly, it may be used to decide whether a particular active blob track is ‘normal’. The SS histogram may be similar to the P-V-S histogram except the vector may only include a starting-position and stop-position. A blob may be seen as stopped as soon as the state-change counter reached 5, as an example. It is noted that the term “blob” used herein may also refer to an object, a person, a vehicle, a transaction, a timing event or any other training attribute of interest to the Analyst.

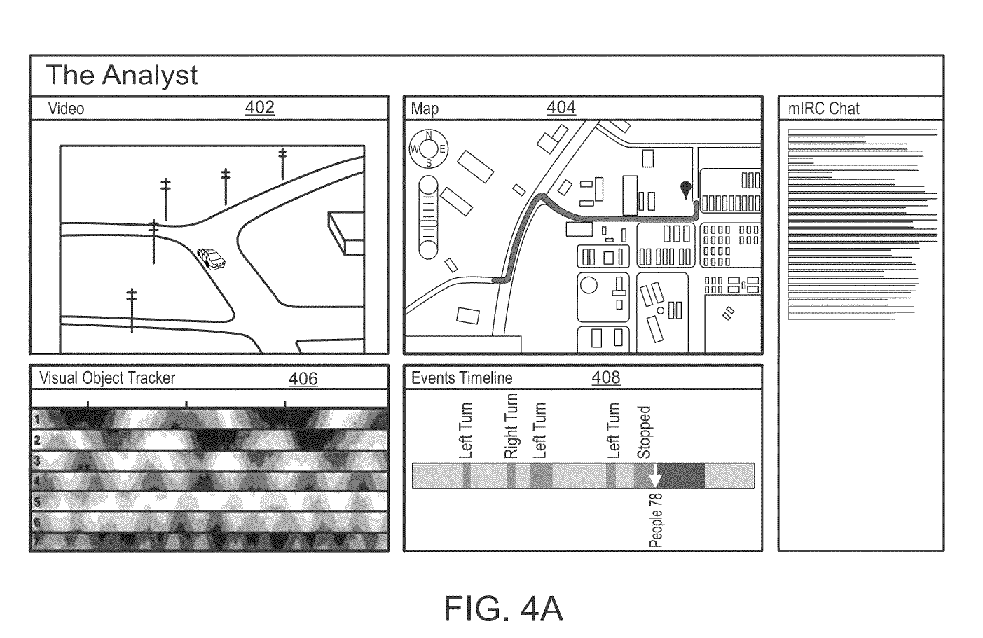

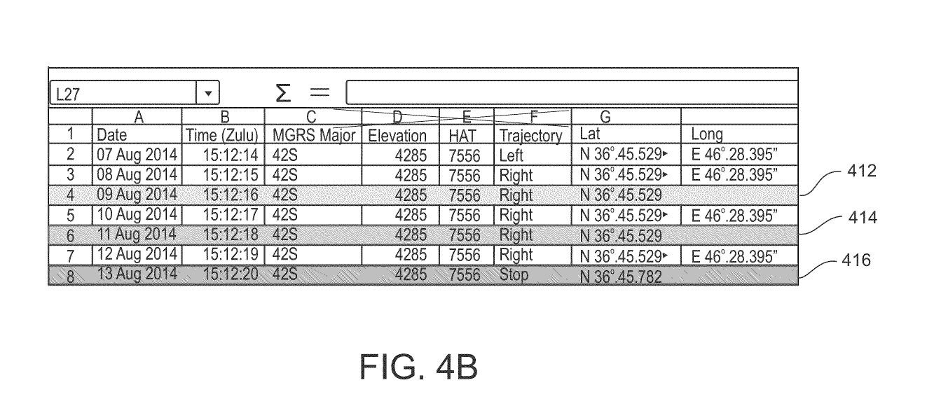

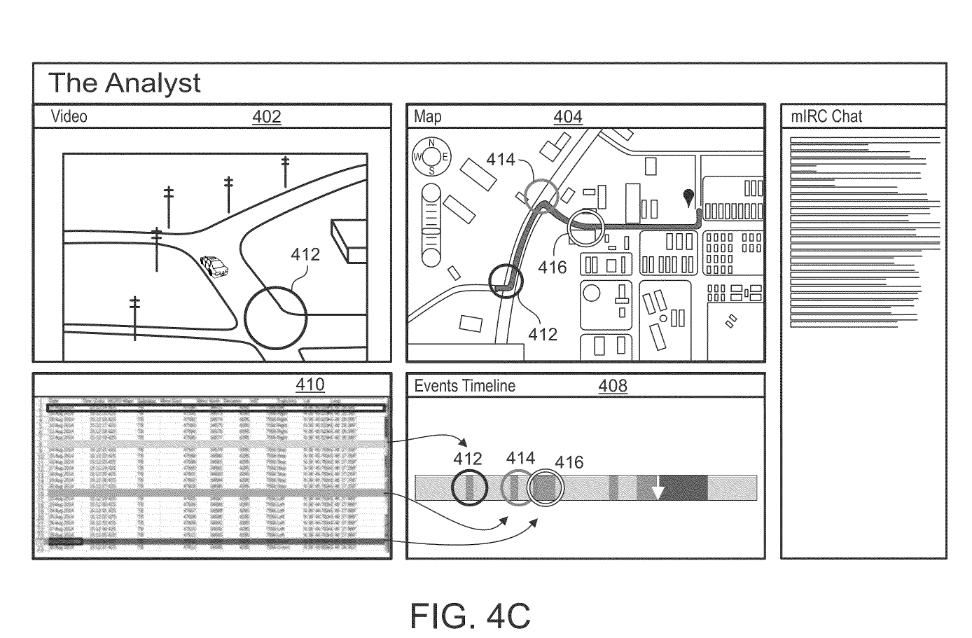

FIGS. 4A-4C are screen displays 400 of example user interfaces for automatic metadata classifier tagging and cataloging optimal actionable intelligence according to embodiments of the present disclosure. FIGS. 4A-4C illustrate a first user interface 402 of a data feed 310 (e.g. FMV from a Predator drone). In this example, a vehicle may be an identified training attribute selected from a list of pre-identified attributes and is tracked or flagged as an object or blob of interest in the data feed within the first user interface 402. A second user interface 404 may display information corresponding to the first user interface 402, although the data feed may be FMV from a different angle or other type of information. In this example, the second user interface 404 is showing a map from a second data feed (e.g. GOOGLE EARTH™) with the same identified training attribute (e.g., vehicle captured in the data feed, the vehicle turning, etc.) shown in the first user interface 402. In the second data feed 404, a different training attribute (e.g., vehicle turning) may be noted, flagged or otherwise shown. A sensor event may be defined as having occurred when the vehicle makes a turn or sequence of turns matching a selected training attribute. A sensor event may be defined as the vehicle making a particular turn onto an identified street or a sequence of turns (e.g., the vehicle circles a geographic point of interest). The screen display 400 further shows a third user interface 406 which may illustrate other data from a data feed 310 or mathematically derived based on the trained attributes and/or the data feed 310. As an example, the third user interface 406 displays a noise-like pattern of pixel-to-pixel non-uniformity pattern, which may be invisible to the human eye and which may create a unique reference pattern or digital pixel fingerprint map. The screen display 400 may also include a fourth user interface 408 illustrating a timeline of sensor events and the timing of their occurrence. It is noted that more or fewer user interfaces may be displayed, wherein the user interface content displayed may be based on data feeds or derived data based on sensor events.

FIG. 4B illustrates a fifth user interface 410 (e.g., a spreadsheet) including information either acquired from a data feed (e.g., using a text source) or derived from a data feed (e.g., determining GPS coordinates from a FMV data feed). In this example, data that may be of interest may include, but not be limited to, date, time, longitude, latitude, elevation, trajectory, and the like. The information included in the fifth user interface 410 may display precise vehicle location coordinates at various timing intervals.

FIG. 4C illustrates a correspondence of the textual data in the fifth user interface 410 to particular sensor events on the timeline in the fourth user interface 408. It may be desired to highlight or flag various events of particular interest to the analyst as sensor events based on the selected training events and/or metadata classifier tags. As an example, one or more vehicle turn events 412, 414, 416 may be highlighted in the fifth user interface 410. Additionally, the vehicle turn events 412, 414, 416 may be highlighted correspondingly in other user interface windows 402, 404, 408.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter In the case of program code execution on programmable computers, the computer can generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method for automatic metadata tagging and cataloging optimal actionable intelligence, the method comprising:
using at least one processor and memory for:
receiving at least one training attribute of a plurality of pre-identified attributes;
creating at least one metadata classifier tag based on the at least one training attribute;
receiving a data feed from at least one data feed source for analysis based on the at least one metadata classifier tags;
applying the created metadata classifier tags to the data feed; and
detecting a sensor event based on the applied metadata classifier tag to the data feed.

2. The method of claim 1, further comprising generating a notification of a sensor event based on the at least one metadata classifier tag.

3. The method of claim 2, wherein generating the notification of a sensor event comprises referencing a video clip out portion comprising the sensor event.

4. The method of claim 3, wherein the video clip out event is based on a variable time lapse scale.

5. The method of claim 1, further comprising determining an analysis priority of the data feed in response to generating a metadata catalogue.

6. The method of claim 1, further comprising storing the at least one training attribute as the at least one metadata classifier tag based on the pre-identified attributes.

7. The method of claim 6, wherein the pre-identified attribute is at least one of a person, an object, a geographical location and a time.

8. The method of claim 1, recording the received data feed.

9. The method of claim 1, wherein the data feed from the at least one data feed source is in a data format comprising at least one of text, audio and video.

10. The method of claim 1, wherein receiving at least one training attribute is comprised of receiving a user input from at least one of a keyboard, a display, a digital input pad, an audio input and a video input.

11. A system for automatic metadata tagging and cataloging optimal actionable intelligence, the system comprising:
a computing device comprising a processor and memory, wherein the computing device is configured to:
receive at least one training attribute of a plurality of pre-identified attributes;
create at least one metadata classifier tag based on the at least one training attribute;
receive a data feed from at least one data feed source for analysis based on the at least one metadata classifier tags;
apply the created metadata classifier tags to the data feed; and
detect a sensor event based on the applied metadata classifier tag to the data feed.

12. The system of claim 11, wherein the computing device is further configured to generate a notification of a sensor event based on the at least one metadata classifier tag.

13. The system of claim 12, wherein generating the notification of a sensor event comprises a reference to a video clip out portion comprising the sensor event.

14. The system of claim 13, wherein the video clip out is based on a variable time lapse scale.

15. The system of claim 1, wherein the computing device is further configured to determine an analysis priority of the data feed in response to generating a metadata catalogue.

16. The system of claim 1, wherein the computing device is further configured to store the at least one training attribute as the at least one metadata classifier tag based on the pre-identified attributes.

17. The system of claim 16, wherein the pre-identified attribute is at least one of a person, an object, a geographical location and a time.

18. The system of claim 1, wherein the computing device is further configured to record the received data feed.

19. The system of claim 1, wherein the data feed from the at least one data feed source is in a data format comprising at least one of text, audio and video.

20. The system of claim 1, wherein the computing device is configured to receive at least one training attribute as a user input from at least one of a keyboard, a display, a digital input pad, an audio input and a video input.
